(19) United States
(12) Patent Application Publication
(10) Pub. No.: US 2006/0257149 A1
(43) Pub. Date: Nov. 16, 2006

(54) Method and apparatus for accommodating multiple optical segments in an Ethernet passive optical network

(76) Inventors: Ryan E. Hirth, Windsor, CA (US); Edward W. Boyd, Petaluma, CA (US); Hoa Nhu Phan, Petaluma, CA (US)

Correspondence Address: PARK, VAUGHAN & FLEMING LLP, 2820 FIFTH STREET, DAVIS, CA, 95618-7759, US

(21) Appl. No.: 11/130,731

(22) Filed: May 16, 2005

(51) Int. Cl. H04J 14/00

(52) U.S. Cl. 398/72

(57) ABSTRACT

One embodiment of the present invention provides a system that accommodates multiple optical segments in an Ethernet passive optical network (EPON), wherein the EPON includes a central node and a number of remote nodes, and wherein the remote nodes reside in a number of optical segments. During operation, the system transmits downstream data from the central node to the remote nodes by broadcasting the data to the optical segments. In addition, the system selectively allows an optical segment to communicate with the central node during an upstream transmission period assigned to a remote node residing in that optical segment, thereby accommodating multiple optical segments and hence an increased number of remote nodes within the EPON.

### BACKGROUND

1. Field of the Invention

The present invention relates to architectures for communication networks. More specifically, the present invention relates to a method and an apparatus for accommodating multiple optical segments in an Ethernet passive optical network.

2. Related Art

In order to keep pace with the increasing Internet traffic, optical fibers and optical transmission equipment have been widely deployed to substantially increase the capacity of backbone networks. However, this capacity increase in backbone networks has not been accompanied by a corresponding capacity increase in access networks. Despite improved broadband access solutions such as digital subscriber line (DSL) and cable modem (CM), the limited bandwidth offered by current access networks remains to be a severe bottleneck in delivering high bandwidth to end users.

Among the different technologies presently being developed, Ethernet passive optical networks (EPONs) are among the best candidates for next-generation access networks. EPONs combine ubiquitous Ethernet technology with inexpensive passive optics. They offer the simplicity and scalability of Ethernet with the cost-efficiency and high capacity of passive optics. Because of optical fiber's high bandwidth, EPONs can carry broadband voice, data, and video traffic simultaneously. Such integrated services are difficult to provide with DSL or CM technology. Furthermore, EPONs are more suitable for Internet Protocol (IP) traffic, because Ethernet frames can encapsulate native IP packets with different sizes. In contrast, ATM passive optical networks (APONs) use fixed-size ATM cells and require packet fragmentation and reassembly.

Typically, EPONs reside in the “first mile” of the network, which provides connectivity between the service provider's central offices and business or residential subscribers. This first mile network is often a logical point-to-multipoint network, with a central office servicing a number of subscribers. In a typical tree-topology EPON, one fiber couples the central office to a passive optical coupler/splitter, which divides and distributes downstream optical signals to users (subscribers). The coupler/splitter also combines upstream signals from subscribers (see FIG. 1).

Transmissions in an EPON are typically between an optical line terminal (OLT) and optical networks units (ONUs) (see FIG. 2). The OLT generally resides in the central office and couples the optical access network to an external network (e.g., a carrier network). An ONU can be located either at the curb or at an end-user location, and can provide broadband voice, data, and video services. ONUs are typically coupled to a one-by-N (1×N) passive optical coupler, which is coupled to the OLT through a single optical link. (Note that a number of optical couplers can be cascaded.) This configuration can achieve significant savings in the number of fibers and amount of hardware.

Communications within an EPON are divided into downstream traffic (from OLT to ONUs) and upstream traffic (from ONUs to OLT). In the upstream direction, the ONUs share channel capacity and resources, since there is only one link coupling the passive optical coupler to the OLT. In the downstream direction, because of the broadcast nature of the 1×N passive optical coupler, packets are broadcast by the OLT to all ONUs and are subsequently extracted by their destination ONUs. Each network device is assigned a Logical Link ID (LLID), according to the IEEE 802.3ah standard. A downstream packet is first processed at the OLT, where the packet receives the LLID of its destination, and is then transmitted to the ONUs. Although a packet is broadcast to all the ONUs, only the ONUs with an LLID that matches the one carried by the packet is allowed to receive the packet. Therefore, the OLT switches packets by attaching proper LLIDs to the packets. Note that in certain cases where broadcast or multicast is desired, the OLT attaches a corresponding broadcast/multicast LLID to a downstream packet so that a number of ONUs are allowed to receive the packet.

One challenge in designing a scalable, cost-effective EPON is to accommodate as many ONUs as possible. Based on the current IEEE 802.3ah standard, one OLT can accommodate up to 256 LLIDs. However, it is not likely that all 256 ONUs can reside in the same optical network segment. This is because the number of ONUs in a tree-topology EPON is limited by the optical power budget and the loss incurred at the optical splitter. A typical optical splitter may have up to 32 ports. A single optical splitter with a higher-port count (e.g., 128 or 256) or a cascaded configuration of multiple splitters inevitably incurs significantly higher loss and leaves little power budget for optical transmission.

One approach to combat high splitting loss is to use a high-power laser for upstream transmission within each ONU. Alternatively, the system may employ optical amplification. Unfortunately, the costs associated with either of these solutions may be prohibitively high.

Hence, what is needed is a method and an apparatus for accommodating an increased number of ONUs in an EPON without incurring significant costs.

### SUMMARY

One embodiment of the present invention provides a system that accommodates multiple optical segments in an Ethernet passive optical network (EPON), wherein the EPON includes a central node and a number of remote nodes, and wherein the remote nodes reside in a number of optical segments. During operation, the system transmits downstream data from the central node to the remote nodes by broadcasting the data to the optical segments. In addition, the system selectively allows an optical segment to communicate with the central node during an upstream transmission period assigned to a remote node residing in that optical segment, thereby accommodating multiple optical segments and hence an increased number of remote nodes within the EPON.

In a variation of this embodiment, the optical segments are coupled to a number of inputs of a multiplexer. The output of the multiplexer is coupled to the central node. In this variation, selectively allowing the optical segment to communicate with the central node involves configuring the multiplexer so that the upstream data from that optical segment can be received by the central node.

In a further variation, the system periodically broadcasts discovery windows to the optical segments. By responding during the discovery window, a newly joined remote node may register with the central node and receive a logical link identifier (LLID). Furthermore, the system configures the multiplexer to allow only one optical segment to communicate with the central node during a given discovery window. The system then associates the LLID assigned to a remote node which is registered during this discovery window with the optical segment which is allowed to communicate with the central node during the same discovery window. In this way, the system can properly configure the multiplexer during the registered remote node's subsequent upstream transmission.

In a further variation, selectively allowing the optical segment to communicate with the central node involves detecting a special bit pattern transmitted from that optical segment.

In a further variation, selectively allowing the optical segment to communicate with the central node involves detecting the signal power level received from that optical segment. In a variation of this embodiment, broadcasting the downstream data to the optical segments involves broadcasting the data electrically to a number of optical transmitters and transmitting the data with one optical transmitter for each optical segment.

In a variation of this embodiment, broadcasting the downstream data to the optical segments involves transmitting the data through one optical transmitter and broadcasting the data to all the optical segments with an optical splitter.

In a variation of this embodiment, the system protects an optical segment by using another optical segment as a backup segment. When a failure occurs in the protected optical segment, the system allows the backup optical segment to replace the failed optical segment.

In a variation of this embodiment, the system deserializes upstream bits received from an optical segment subsequent to selectively allowing that optical segment to communicate with the central node. In addition, the system serializes downstream bits transmitted from the central node prior to broadcasting the data to the optical segments.

### BRIEF DESCRIPTION OF THE FIGURES

FIG. 1 illustrates a passive optical network wherein a central office and a number of subscribers are coupled through optical fibers and a passive optical splitter.

FIG. 2 illustrates an EPON in normal operation mode.

FIG. 3 illustrates an OLT configuration which uses an electrical multiplexer to accommodate multiple optical segments in accordance to one embodiment of the present invention.

FIG. 4 illustrates a multi-optical segment OLT configuration where downstream data is transmitted by a single high-power laser in accordance to one embodiment of the present invention.

FIG. 5 presents a flow chart illustrating the process of associating an ONU's LLID with an input port of the multiplexer during a discovery process in accordance with an embodiment of the present invention.

FIG. 6 presents a flow chart illustrating the process of protection switching using multiple optical segments in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures, operations, and processes described in this detailed description are typically stored on a digital-logic-readable storage medium, which may be any device or medium that can store code, data, instructions, and/or operation sequences for use by a digital-logic system such as a computer system. This includes, but is not limited to, application specific integrated circuits (ASICs), field-programmable gate arrays (FPGAs), semiconductor memories, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated).

Passive Optical Network Topology

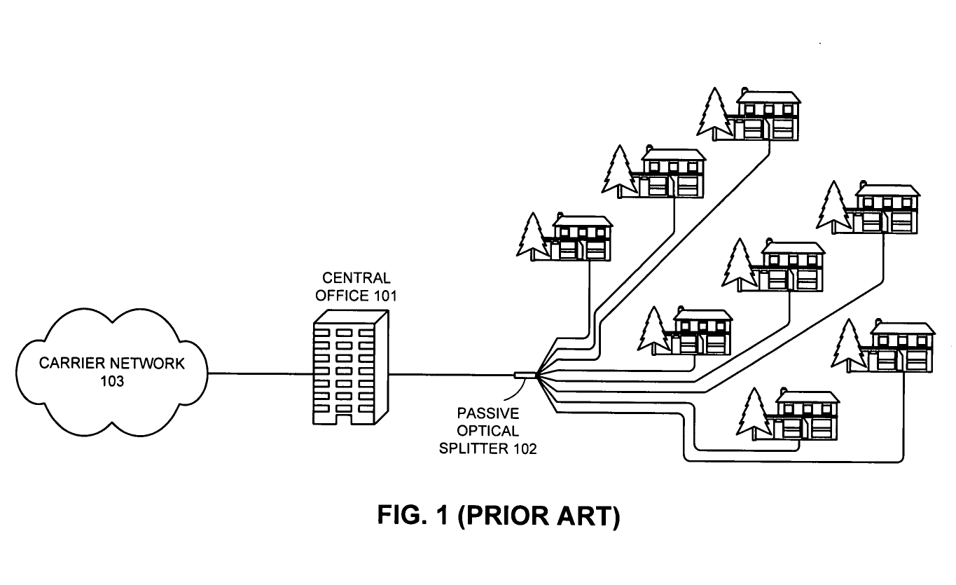

FIG. 1 illustrates a passive optical network, wherein a central office and a number of subscribers form a tree topology through optical fibers and a passive optical splitter. As shown in FIG. 1, a number of subscribers are coupled to a central office 101 through optical fibers and a passive optical splitter 102. Passive optical splitter 102 can be placed near end-user locations, so that the initial fiber deployment cost is minimized. The central office is coupled to an external network, such as a metropolitan area network operated by an ISP.

EPON Operation

An ONU typically can accommodate one or more networked devices, such as personal computers, telephones, video equipment, network servers, etc. Note that an ONU can identify itself by using a Logical Link Identifier (LLID), as defined in the IEEE 802.3ah standard. To allow ONUs to join an EPON at arbitrary times, an EPON has two modes of operation: a discovery (initialization) mode and a normal operation mode. The discovery mode allows newly joined ONUs to register with the OLT and receives an LLID from the OLT. The normal operation mode allows regular upstream data transmissions, where transmission opportunities are assigned to all initialized ONUs.

In a discovery process, an OLT broadcasts a discovery solicitation message to all the ONUs, including a newly joined unregistered ONU. The discovery solicitation message typically specifies the start time of a discovery window during which an unregistered ONU may register with the OLT. When the discovery window arrives for the unregistered ONU, the ONU sends a response message which contains the ONU's MAC address. The OLT subsequently assigns an LLID to the ONU.

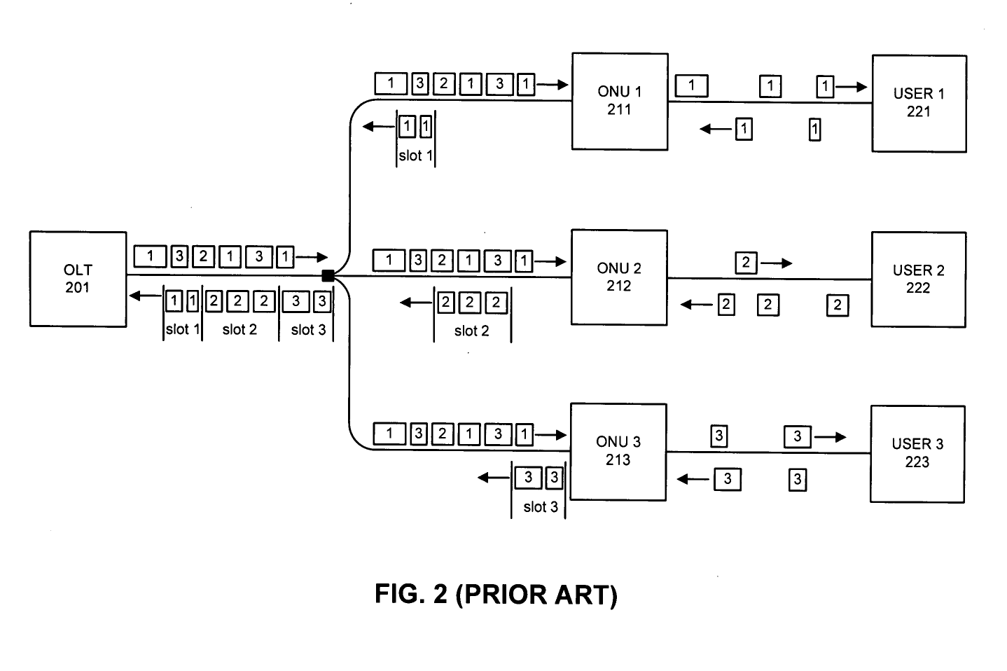

FIG. 2 illustrates an EPON in normal operation mode. As shown in FIG. 2, in the downstream direction, an OLT 201 broadcasts downstream data to ONU 1 (211), ONU 2 (212), and ONU 3 (213). While all ONUs receive the same copy of downstream data, each ONU selectively forwards only the data destined to itself to its corresponding users, which are user 1 (221), user 2 (222), and user 3 (223), respectively.

For the upstream traffic, OLT 201 first schedules and assigns transmission windows to each ONU according to the ONU's service-level agreement. When not in its transmission window, an ONU typically buffers the data received from its user. When its scheduled transmission window arrives, an ONU transmits the buffered user data within the assigned transmission window. Since every ONU takes turns in transmitting upstream data according to the OLT's scheduling, the upstream link's capacity can be efficiently utilized.

Accommodating Multiple Optical Segments in EPON

A challenge in designing a scalable and cost effective EPON is to accommodate a large number of ONUs. Currently, the IEEE 802.3ah standard allows over 32,000 LLIDs in an EPON. However, these LLIDs are not all used. This is because the number of optical branches fanning out from an optical splitter is limited by the splitting loss and the optical power budget. Optical splitters commercially available today can have up to 32 ports. Although a single splitter with a higher port count or a cascaded splitter configuration provide an increased number of output ports, these configurations incur excessive splitting loss and quickly deplete the optical power budget in the EPON.

It is possible to use high-power lasers to compensate for the excessive splitting loss. However, using a high-power laser in every ONU for upstream transmission inevitably increases the ONU cost. Consequently, the overall cost of the entire EPON can be prohibitively high.

One embodiment of the present invention effectively increases the total number of ONUs in an EPON by accommodating multiple optical segments. In the downstream direction, data is broadcast to all the optical segments. In the upstream direction, different optical segments are interfaced with an electrical multiplexer which allows one segment to communicate with the OLT at a time.

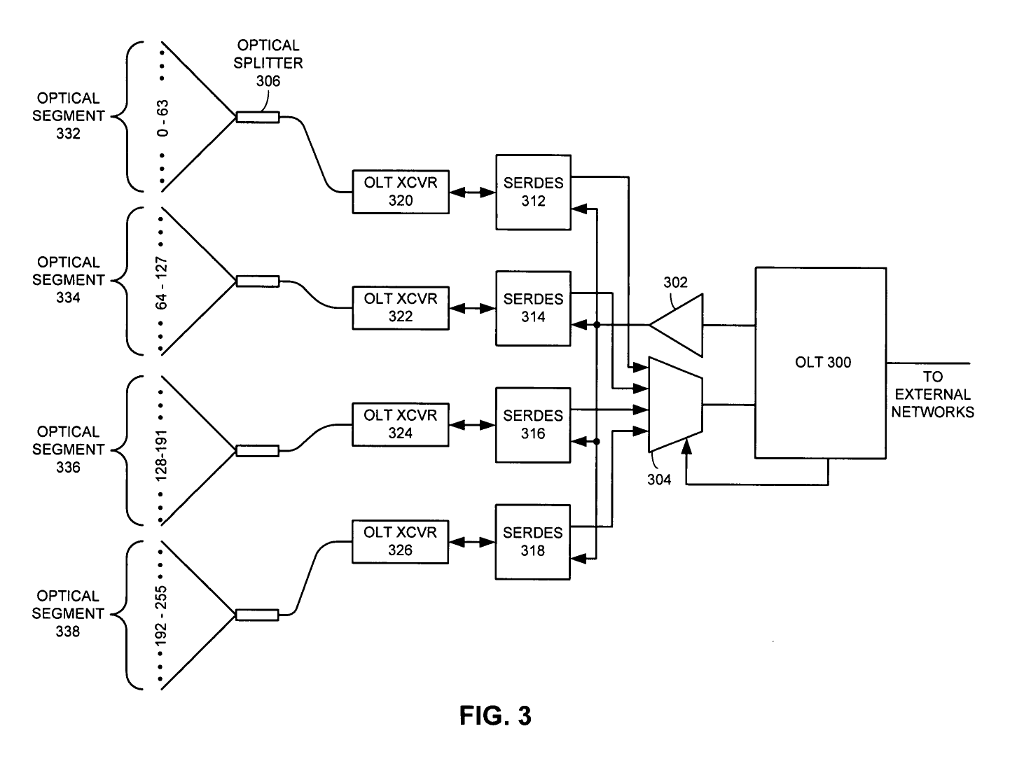

FIG. 3 illustrates an OLT configuration which uses an electrical multiplexer to accommodate multiple optical segments in accordance to one embodiment of the present invention. In this example, the EPON includes four optical segments 332, 334, 336, and 338. Each optical segment has a tree topology and can accommodate up to 64 ONUs with a 1×64 optical splitter. Within an optical segment, the ONUs are coupled to the branch optical fibers which are coupled to a main fiber through the optical splitter, such as splitter 306. The main fibers are coupled to OLT transceivers (XCVR) 320, 322, 324, and 326, respectively. The OLT transceivers perform the optical-to-electrical and electrical-to-optical signal conversion.

The optical transceivers are in communication with serializers/deserializers (SERDES) 312, 314, 316, and 318. A SERDES is responsible for converting a serial bit stream received from the fiber side (upstream) to a stream of n-bit wide words (e.g., 10-bit wide words) which can be received by digital interfaces typically used by an OLT chip. Similarly, the SERDES can receive n-bit wide words from the OLT and convert them into a serial bit stream which can be transmitted downstream by an OLT transceiver. Note that, in this example, a transceiver is a combination of an optical transmitter (e.g., a laser) and a receiver, and is therefore capable of both transmitting and receiving optical signals.

The upstream outputs of the four SERDES' are coupled to a 4×1 electrical multiplexer 304. Multiplexer 304 can be configured to allow one of these inputs to communicate to its output which is coupled to OLT 300. Because different optical segments share the same upstream link to OLT 300, only one optical segment can be allowed to transmit upstream data to OLT 300 at any time. Therefore, the use of an electrical multiplexer is compatible with the existing mode of operation of an EPON.

In the downstream direction, data from OLT 300 (typically n-bit wide words) is first amplified by an electrical transmission buffer 302 and then broadcast to SERDES' 312, 314, 316, and 318. The SERDES' convert the downstream data into serial bit streams which are subsequently transmitted to the optical segments by the OLT transceivers.

The configuration in FIG. 3 effectively adopts an additional level of aggregation in the electrical domain to accommodate multiple optical segments. In the upstream direction, the system uses electrical multiplexer 304 to allow one segment to communicate with OLT 300 at a time. In the downstream direction, the system electrically broadcasts the data to all the optical segments, which further broadcast the data to their ONUs through the optical splitters.

The advantage of this configuration is that from OLT 300's perspective, there is no difference between coupling to a single optical segment and coupling to multiple optical segments through an electrical multiplexer. In addition, the costs of electrical multiplexers, SERDES', and optical transceivers are significantly lower than those of high-power lasers or optical amplifiers. Therefore, the configuration disclosed herein provides unprecedented scalability, seamless interoperability, and excellent cost-effectiveness.

It is important for multiplexer 304 to switch between its inputs at proper times so that each optical segment can successfully transmit upstream data to OLT 300 during its assigned transmission windows. In one embodiment of the present invention, the configuration of multiplexer 304's switching state is based on the presence of signals on its inputs. For example, the system can use an electrical signal detection mechanism at the upstream outputs of the SERDES, and configure multiplexer 304 to turn on the input port whose signal level exceeds a given threshold. Alternatively, the system can use an optical signal detection mechanism at the OLT transceivers to detect the level of optical power and configure multiplexer 304 accordingly. Furthermore, when an optical segment is communicating with OLT 300, the system may prohibit multiplexer 304 from changing its switching state to ensure uninterrupted communication from that optical segment.

It is also possible for multiplexer 304 to implement some intelligence and to configure itself based on received data. In one embodiment of the present invention, multiplexer 304 may include a mechanism which scans the incoming n-bit words on every input. Whenever an incoming word matches a special bit pattern which is designated to mark the beginning of an upstream transmission from an ONU, multiplexer 304 may automatically switch to that input and allows its upstream transmission to pass through.

Another approach to configuring multiplexer 304 is to allow OLT 300 to control multiplexer 304. In one embodiment of the present invention, OLT 300 maintains knowledge of which optical segment is allowed to transmit upstream data at any given time. OLT 300 can send a control signal to multiplexer 304 to switch to a proper optical segment when it is time for OLT 300 to receive from that segment.

For OLT 300 to properly configure multiplexer 304, OLT 300 ideally learns which ONU/LLID corresponds to which optical segment. In this way, OLT 300 can predict at the beginning of each upstream transmission window from which optical segment the data is sent. One way for OLT 300 to map LLIDs to optical segments is to direct its discovery process to individual optical segments. Conventionally, an OLT broadcasts a discovery window to every ONU and accepts registration requests from any newly joined ONUs. Conversely, in one embodiment of the present invention, OLT 300 selectively listens to a particular optical segment during a discovery window by configuring multiplexer 304 to switch to that segment. Hence, any newly joined ONU registered during this discovery window is associated with that optical segment. Note that the discovery window may still be broadcast to all the optical segments. However, only registration requests from one segment are received by OLT 300.

Note that the downstream broadcasting and upstream multiplexing may also occur between the optical transceivers and a SERDES. In this case, an upstream multiplexer is placed between the optical transceivers and one SERDES. The input ports of this multiplexer ideally operate at a higher serial bit rate (i.e., line rate). The output of this multiplexer then enters the SERDES and the bit stream is then parallelized. In the downstream direction, the broadcasting occurs after the downstream bits from the OLT are serialized. This configuration allows the electrical broadcasting and multiplexing to occur in the serial domain and therefore reduces the number of SERDES'.

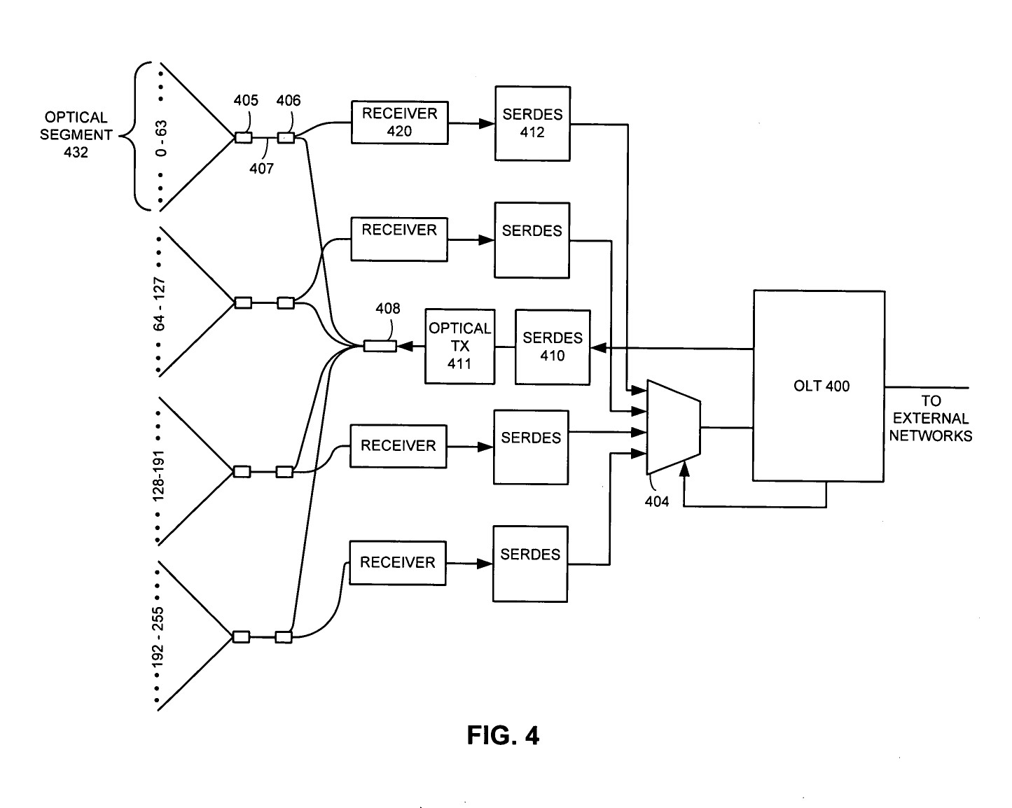

In the example in FIG. 3, the system electrically broadcasts downstream data to all the optical segments. Alternatively, the system can use a single high-power laser and optically broadcast the downstream data. FIG. 4 illustrates a multi-optical segment OLT configuration where downstream data is transmitted by a single high-power laser in accordance to one embodiment of the present invention.

As shown in FIG. 4, an OLT 400 transmits its downstream data to a SERDES 410 which converts n-bit wide words into a serial bit stream. The serial bit stream is then transmitted to an optical transmitter (TX) 411, which is a high-power laser. The output of optical transmitter 411 then enters a 1×4 optical splitter 408, which optically broadcasts the downstream data to four optical segments. Within one optical segment, for example segment 432, the output of splitter 408 enters a main fiber 407 through a 2×1 optical combiner 406. 2×1 combiner 406 is used here to facilitate both upstream and downstream transmission through main fiber 407. After propagating through main fiber 407, the downstream data enters optical splitter 405 which broadcasts the optical signal to all the ONUs within optical segment 432.

In the upstream direction, data from an ONU within segment 432 is transmitted upstream through splitter 405 (working as a combiner), main fiber 407, and combiner 406 (working as a splitter) to reach optical receiver 420. The output of receiver 420 is transmitted to SERDES 412, which converts a serial bit stream in to n-bit wide words. The outputs of the four SERDES' (corresponding to four optical segments) subsequently enter electrical multiplexer 404, which selects one of the optical segments to communicate with OLT 400.

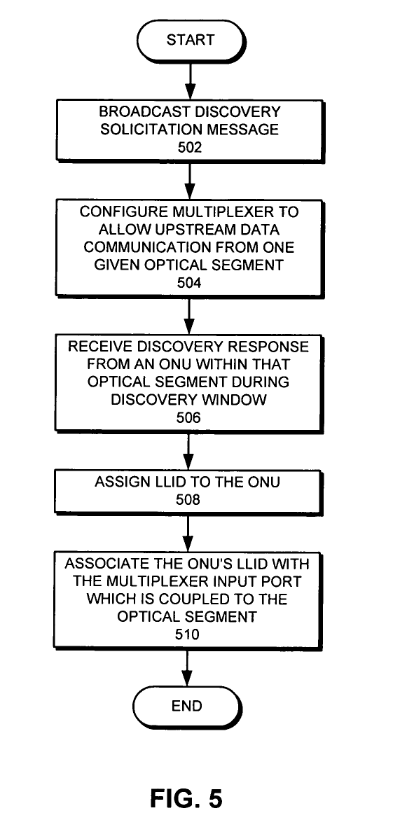

FIG. 5 presents a flow chart illustrating the process of associating an ONU's LLID with an input port of the multiplexer during a discovery process in accordance with an embodiment of the present invention. The system begins by broadcasting a discovery solicitation message to all the optical segments (step 502). The system then configures the multiplexer to allow upstream data communication from one given optical segment during the assigned discovery window (step 504).

Next, the system receives a discovery response from an ONU within that optical segment during the discovery window (step 506). The system subsequently assigns an LLID to the requesting ONU (step 508). The system also associates the ONU's LLID with the multiplexer's input port which is coupled to the optical segment (step 510).

A multiple-optical segment configuration in an EPON can also be used for protection switching. For example, one optical segment can be used as a backup for a primary optical segment. When a failure (e.g., an ONU failure or a fiber cut) occurs in the primary segment, the OLT can quickly switch to the backup segment and minimize transmission interruption. Such fast protection switching provides valuable quality of service (QoS) in critical applications, such as voice communications.

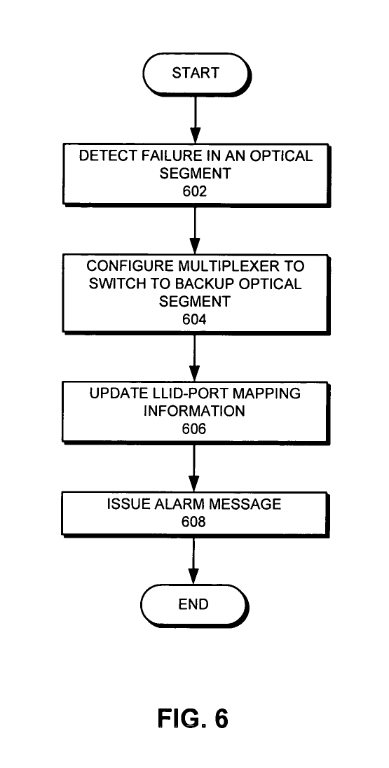

FIG. 6 presents a flow chart illustrating the process of protection switching using multiple optical segments in accordance with an embodiment of the present invention. During operation, the system first detects a failure in an optical segment (step 602). The system then configures the multiplexer to switch to the backup optical segment (step 604). Next, the system updates the LLID-to-multiplexer port mapping information to reflect that the backup segment has replaced the primary segment (step 606). The system subsequently issues an alarm message to alert the network operator (step 608).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for accommodating multiple optical segments in an Ethernet passive optical network (EPON), wherein the EPON includes a central node and a number of remote nodes, and wherein the remote nodes reside in a number of optical segments, the method comprising:
transmitting downstream data from the central node to the remote nodes by broadcasting the data to the optical segments; and
selectively allowing an optical segment to communicate with the central node during an upstream transmission period assigned to a remote node residing in that optical segment, thereby accommodating multiple optical segments and hence an increased number of remote nodes within the EPON.

2. The method of claim 1,
wherein the optical segments are coupled to a number of inputs of a multiplexer;
wherein the output of the multiplexer is coupled to the central node; and
wherein selectively allowing the optical segment to communicate with the central node involves configuring the multiplexer so that the upstream data from that optical segment can be received by the central node.

3. The method of claim 2, further comprising:
periodically broadcasting discovery windows to the optical segments, where a newly joined remote node may register with the central node and receive a logical link identifier (LLID);
configuring the multiplexer to allow only one optical segment to communicate with the central node during a given discovery window; and
associating the LLID assigned to a remote node which is registered during this discovery window with the optical segment which is allowed to communicate with the central node during the same discovery window, thereby facilitating proper configuration of the multiplexer during the registered remote node's subsequent upstream transmission.

4. The method of claim 2, wherein selectively allowing the optical segment to communicate with the central node involves detecting a special bit pattern transmitted from that optical segment.

5. The method of claim 2, wherein selectively allowing the optical segment to communicate with the central node involves detecting the signal power level received from that optical segment.

6. The method of claim 1, wherein broadcasting the downstream data to the optical segments involves broadcasting the data electrically to a number of optical transmitters and transmitting the data with one optical transmitter for each optical segment.

7. The method of claim 1, wherein broadcasting the downstream data to the optical segments involves transmitting the data through one optical transmitter and broadcasting the data to all the optical segments with an optical splitter.

8. The method of claim 1, further comprising:
protecting an optical segment by using another optical segment as a backup segment; and
when a failure occurs in the protected optical segment, allowing the backup optical segment to replace the failed optical segment.

9. The method of claim 1, further comprising:
deserializing upstream bits received from an optical segment subsequent to selectively allowing that optical segment to communicate with the central node; and
serializing downstream bits transmitted from the central node prior to broadcasting the data to the optical segments.

10. An apparatus for accommodating multiple optical segments in an EPON, wherein the EPON includes a central node and a number of remote nodes, and wherein the remote nodes reside in a number of optical segments, the apparatus comprising:
a transmission mechanism configured to transmit downstream data from the central node to the remote nodes by broadcasting the data to the optical segments; and
a selection mechanism configured to selectively allow an optical segment to communicate with the central node during an upstream transmission period assigned to a remote node residing in that optical segment, thereby accommodating multiple optical segments and hence an increased number of remote nodes within the EPON.

11. The apparatus of claim 10,
wherein the selection mechanism comprises a multiplexer;
wherein the optical segments are coupled to a number of inputs of the multiplexer;
wherein the output of the multiplexer is coupled to the central node; and
wherein while selectively allowing the optical segment to communicate with the central node, the selection mechanism is configured to configure the multiplexer so that the upstream data from that optical segment can be received by the central node.

12. The apparatus of claim 11,
wherein the transmission mechanism is configured to periodically broadcast discovery windows to the optical segments, where a newly joined remote node may register with the central node and receive an LLID;
wherein the selection mechanism is configured to configure the multiplexer to allow only one optical segment to communicate with the central node during a given discovery window; and
wherein the selection mechanism is further configured to associate the LLID assigned to a remote node which is registered during this discovery window with the optical segment which is allowed to communicate with the central node during the same discovery window, thereby facilitating proper configuration of the multiplexer during the registered remote node's subsequent upstream transmission.

13. The apparatus of claim 11, wherein while selectively allowing the optical segment to communicate with the central node, the selection mechanism is configured to detect a special bit pattern transmitted from that optical segment.

14. The apparatus of claim 11, wherein while selectively allowing the optical segment to communicate with the central node, the selection mechanism is configured to detect the signal power level received from that optical segment.

15. The apparatus of claim 10,
wherein the transmission mechanism comprises a number of optical transmitters; and
wherein while broadcasting the downstream data to the optical segments, the transmission mechanism is configured to broadcast the data electrically to a number of optical transmitters and to transmit the data with one optical transmitter for each optical segment.

16. The apparatus of claim 10,
wherein the transmission mechanism comprises an optical transmitter and an optical splitter; and
wherein while broadcasting the downstream data to the optical segments, the transmission mechanism is configured to transmit the data with the optical transmitter and to broadcast the data to all the optical segments with the optical splitter.

17. The apparatus of claim 10, further comprising a protection mechanism configured to protect an optical segment by using another optical segment as a backup segment; and
wherein when a failure occurs in the protected optical segment, the protection mechanism is configured to allow the backup optical segment to replace the failed optical segment.

18. The apparatus of claim 10, further comprising a serializer/deserializer (SERDES) which is configured to:
deserialize upstream bits received from an optical segment subsequent to selectively allowing that optical segment to communicate with the central node; and to
serialize downstream bits transmitted from the central node prior to broadcasting the data to the optical segments.

19. A digital-logic-readable storage medium storing instructions that when executed by a digital logic system cause the system to perform a method for accommodating multiple optical segments in an EPON, wherein the EPON includes a central node and a number of remote nodes, and wherein the remote nodes reside in a number of optical segments, the method comprising:
transmitting downstream data from the central node to the remote nodes by broadcasting the data to the optical segments; and
selectively allowing an optical segment to communicate with the central node during an upstream transmission period assigned to a remote node residing in that optical segment, thereby accommodating multiple optical segments and hence an increased number of remote nodes within the EPON.

20. The digital-logic-readable storage medium of claim 19,
wherein the optical segments are coupled to a number of inputs of a multiplexer;
wherein the output of the multiplexer is coupled to the central node; and
wherein selectively allowing the optical segment to communicate with the central node involves configuring the multiplexer so that the upstream data from that optical segment can be received by the central node.

21. The digital-logic-readable storage medium of claim 20, wherein the method further comprising:
periodically broadcasting discovery windows to the optical segments, where a newly joined remote node may register with the central node and receive an LLID;
configuring the multiplexer to allow only one optical segment to communicate with the central node during a given discovery window; and
associating the LLID assigned to a remote node which is registered during this discovery window with the optical segment which is allowed to communicate with the central node during the same discovery window, thereby facilitating proper configuration of the multiplexer during the registered remote node's subsequent upstream transmission.

22. The digital-logic-readable storage medium of claim 20, wherein selectively allowing the optical segment to communicate with the central node involves detecting a special bit pattern transmitted from that optical segment.

23. The digital-logic-readable storage medium of claim 20, wherein selectively allowing the optical segment to communicate with the central node involves detecting the signal power level received from that optical segment.

24. The digital-logic-readable storage medium of claim 19, wherein broadcasting the downstream data to the optical segments involves broadcasting the data electrically to a number of optical transmitters and transmitting the data with one optical transmitter for each optical segment.

25. The digital-logic-readable storage medium of claim 19, wherein broadcasting the downstream data to the optical segments involves transmitting the data through one optical transmitter and broadcasting the data to all the optical segments with an optical splitter.

26. The digital-logic-readable storage medium of claim 19, wherein the method further comprising:
protecting an optical segment by using another optical segment as a backup segment; and
when a failure occurs in the protected optical segment, allowing the backup optical segment to replace the failed optical segment.

27. The digital-logic-readable storage medium of claim 19, wherein the method further comprising:
deserializing upstream bits received from an optical segment subsequent to selectively allowing that optical segment to communicate with the central node; and
serializing downstream bits transmitted from the central node prior to broadcasting the data to the optical segments.
